(19) United States
(12) Patent Application Publication
(10) Pub. No.: US 2013/0330515 A1
(43) Pub. Date: Dec. 12, 2013

(54) METHOD OF PROCESSING COVER GLASS

(71) Applicant: SAMSUNG DISPLAY CO., LTD., Yongin-City (KR)

(72) Inventors: Ju-Suk OH, Yongin-City (KR); Hyoung-Suk ROH, Yongin-City (KR); Kwan-Young HAN, Yongin-City (KR)

(73) Assignee: SAMSUNG DISPLAY CO., LTD., Yongin-City (KR)

(21) Appl. No.: 13/652,294

(22) Filed: Oct. 15, 2012

(30) Foreign Application Priority Data
Jun. 12, 2012 (KR) 10-2012-0062861

(51) Int. Cl. C03C 15/00; B32B 3/30

(52) U.S. Cl. 428/156; 65/31

(57) ABSTRACT

A method of processing a cover glass. The method includes forming mask layers on opposite surfaces of an original glass substrate for a display; cutting the original glass substrate into a plurality of unit glass substrates each including an opening; chemically etching exposed processing surfaces only by dipping the unit glass substrate in an etching solution; and removing the mask layers by dipping the unit glass substrate in a cleaning solution.

### CROSS-REFERENCE TO RELATED PATENT APPLICATION

This application claims the benefit of Korean Patent Application No. 10-2012-0062861, filed on Jun. 12, 2012, in the Korean Intellectual Property Office, the disclosure of which is incorporated herein in its entirety by reference.

### BACKGROUND

1. Field

The present embodiments relate to a method of processing cover glass.

2. Description of the Related Art

As demands for mobile phones, so-called touchscreen phones, have recently increased, demands for components of mobile phones have also increase. In a touch-screen type mobile phone, there are no buttons on a wide screen and a user manipulates the mobile phone by pressing the screen. A touch-screen type mobile phone includes a window on an outer layer of a display unit so as to prevent scratches on the display unit or to protect the display unit from external shock.

### SUMMARY

The present embodiments provide a method of processing cover glass, which improves the strength of a cover glass for a display.

According to an aspect of the present embodiments, there is provided a method of processing a cover glass, the method including: forming mask layers on opposite surfaces of an original glass substrate for a display; cutting the original glass substrate into a plurality of unit glass substrates each including an opening; chemically etching exposed processing surfaces only by dipping the unit glass substrate in an etching solution; and removing the mask layers by dipping the unit glass substrates in a cleaning solution.

According to another aspect of the present embodiments, there is provided a method of processing a cover glass, the method including: forming mask layers on opposite surfaces of an original glass substrate for a display; cutting the original glass substrate into a plurality of unit glass substrates each including an opening; stacking the plurality of unit glass substrates; chemically etching only exposed processing surfaces of the stacked unit glass substrates by dipping the stacked unit glass substrates in an etching solution; and removing the mask layers by dipping the stacked unit glass substrates in a cleaning solution.

The cutting of the original glass substrate may include processing the opening in each of the unit glass substrates.

The forming of the mask layers may include performing a printing on the opposite surfaces of the original glass substrate by using an ink.

The ink may be an ultraviolet (UV) ink comprising urethane resin or a compound including the urethane resin. The protective film may include acrylic resin and acrylic urethane resin.

The etching solution may include hydrofluoric acid (HF) or a mixed solution of HF and an inorganic acid. The inorganic acid may be one or more selected from the group consisting of hydrochloric acid (HCl), nitric acid (HNO₃), and sulfuric acid (H₂SO₄).

The cutting of the original glass substrate may include cutting the original glass substrate by using a physical process.

According to another aspect of the present embodiments, there is provided a display apparatus comprising a cover glass manufactured by the above method.

### BRIEF DESCRIPTION OF THE DRAWINGS

The above and other features and advantages of the present embodiments will become more apparent by describing in detail example embodiments thereof with reference to the attached drawings in which:

FIG. 1 is an exploded perspective view schematically showing a coupling structure of a touch display device according to an embodiment;

FIGS. 2 through 8 are schematic diagrams illustrating processes of manufacturing a cover glass, according to an embodiment;

FIGS. 9 through 13 are schematic diagrams illustrating processes of manufacturing a cover glass, according to another embodiment; and

FIGS. 14A and 14B are photographs showing processing surfaces before and after a chemical etching process, according to an embodiment.

### DETAILED DESCRIPTION OF THE PREFERRED EMBODIMENT

As the present embodiments allow for various changes and numerous embodiments, particular embodiments will be illustrated in the drawings and described in detail in the written description. However, this is not intended to limit the present embodiments to particular modes of practice, and it is to be appreciated that all changes, equivalents, and substitutes that do not depart from the spirit and technical scope of the present embodiments are encompassed in the present embodiments. In the description of the present embodiments, certain detailed explanations of related art are omitted when it is deemed that they may unnecessarily obscure the essence of the embodiments.

The terminology used herein is for the purpose of describing particular embodiments only and is not intended to be limiting of the embodiments. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the drawings, the thicknesses of layers and regions are exaggerated for clarity. It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Expressions such as “at least one of,” when preceding a list of elements, modify the entire list of elements and do not modify the individual elements of the list.

Hereinafter, structures and operations of the present embodiments will be described in detail with reference to accompanying drawings.

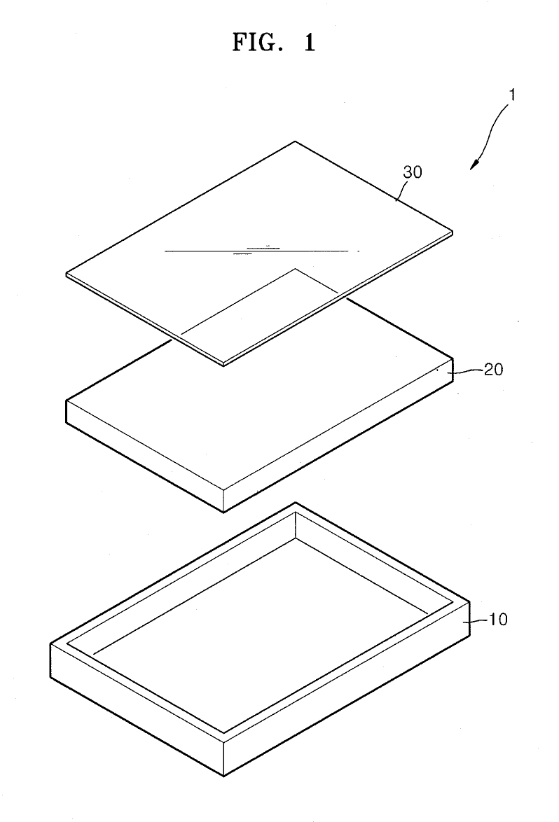

FIG. 1 is an exploded perspective view schematically showing a coupling structure of a touch display device 1 according to an embodiment.

Referring to FIG. 1, the touch display device 1 includes a housing 10, a panel 20 accommodated in the housing 10, and a window 30 coupled to an upper portion of the panel 20.

The housing 10 accommodates the panel 20 and the window 30.

The panel 20 may include a display device such as a liquid crystal display (LCD) or an organic electroluminescence (EL) display so as to display contents according to user manipulation, a display panel on which a printed circuit board and various electronic components are mounted, and a touch-screen panel attached to an outer surface of the display panel. The panel 20 is disposed on an inner side of the housing 10.

The touch-screen panel is an input device for inputting user commands by touching contents displayed on the screen with the finger or an object. To do this, the touch-screen panel is disposed on a front face of the display device to convert a contact location where the human finger or an object contacts into an electric signal. Accordingly, the content selected at the contact location is input as an input signal. The touch-screen panel may substitute for an additional input device such as a keyboard or a mouse. The touch-screen panel may be realized as a resistive film type panel, an optical sensing type panel, and a capacitive type panel. A capacitive touch-screen panel senses a variation of capacitance between a conductive sensing pattern and another adjacent conductive sensing pattern or a ground electrode when the human finger and the object contacts the touch-screen panel, thereby converting the contact location into an electric signal. The window 30 is additionally disposed on an upper surface of the touch-screen panel in order to improve mechanical strength.

Although not shown in FIG. 1, the panel 20 may be fixed in the housing 10 in various ways that are well known in the art.

The window 30 prevents damage such as scratches to the touch display device 10 and infiltration of impurities into the touch display device 10, and protects the touch display device 10 against external shock. In addition, the window 30 may comprise a transparent glass substrate that is tempered. Here, an adhesive (not shown) may be applied between the panel 20 and the window 30 to adhere the panel 20 and the window 30 to each other. The window 30 may have various outer appearances according to an outer shape of the touch display device 1. To do this, a processing operation such as a cutting of an original glass substrate is essentially performed.

Hereinafter, processes of manufacturing the window 30 that covers a screen of a terminal such as a mobile phone, a portable multimedia player (PMP), and a netbook or a reinforcing glass disposed on a rear surface of the terminal will be described. Hereinafter, the window and the reinforcing glass are referred to as a “cover glass.”

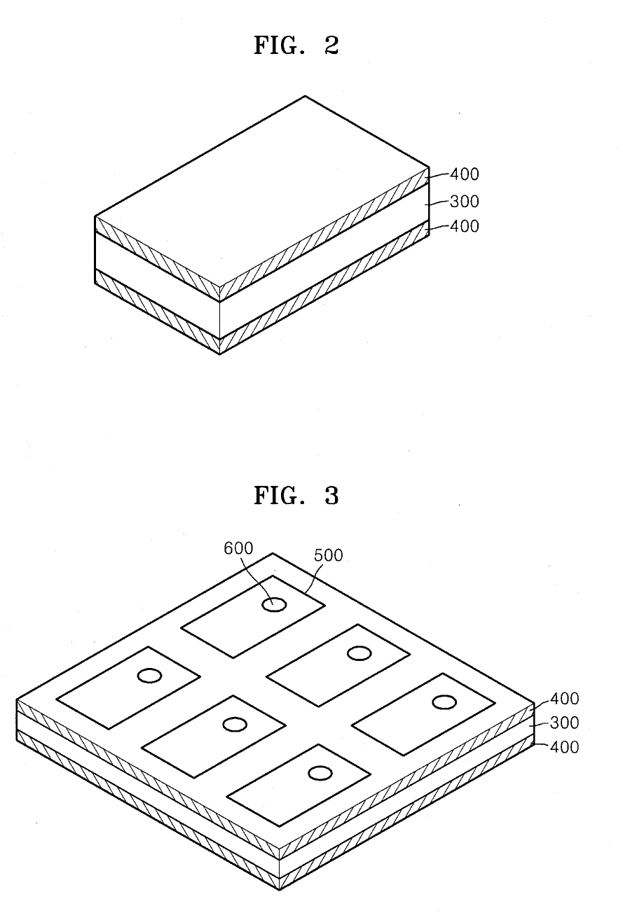

FIGS. 2 through 8 are schematic diagrams illustrating processes of manufacturing a cover glass, according to an embodiment.

Referring to FIG. 2, mask layers 400 are formed on opposite surfaces of an original glass substrate 300 for a display. The mask layers 400 may be formed in various ways, for example, a screen printing method, a laminate film method, and a resist-applying photolithography method. However, the embodiment is not limited thereto, and various printing methods for forming mask layers 400 of predetermined sizes on an original glass substrate 300 may be used.

The mask layers 400 may comprise a material that is not dissolved by an etchant in an etching process that is performed later. For example, the mask layers 400 may be films comprising acrylic resin and acrylic urethane resin, and may be attached to opposite surfaces of the original glass substrate 300. Otherwise, the mask layers 400 may be formed by printing UV ink onto the opposite surfaces of the original glass substrate 300, and then drying the UV ink. At this time, the ink may comprise urethane resin or a compound including the urethane resin, may be fabricated by mixing a hardener, a pigment, an additive, and a solvent in a UV ink resin. The UV ink is applied to a thickness of about 60 to 70 μm by the screen printing method, and then is cured by UV light. An intensity of UV light may range 2500±500 mj/cm² to process and protect the glass.

Referring to FIG. 3, a plurality of cover glass patterns 500 are formed on a mask layer 400 on the surface of the original glass substrate 300 according to a size and a shape of the cover glass to be manufactured, by printing a chemical-resistant ink in a spin coating method. Openings for mounting key buttons, a speaker, a microphone, and a camera are formed in various shapes in the cover glass that includes the window 30 and the reinforcing glass. Therefore, opening patterns 600 are printed in the cover glass patterns 500. Otherwise, the cover glass patterns 500 and the opening patterns 600 may be marked in the mask layer 400 by using a flatbed cutting or a laser cutting method.

In the embodiment of FIG. 3, six cover glass patterns 500 and one opening pattern 600 in each of the cover glass patterns 500 are shown; however, the embodiment is not limited thereto. Six or more cover glass patterns 500 may be formed and opening patterns 600 having various sizes and shapes may be printed or marked at predetermined positions of each cover glass pattern 500.

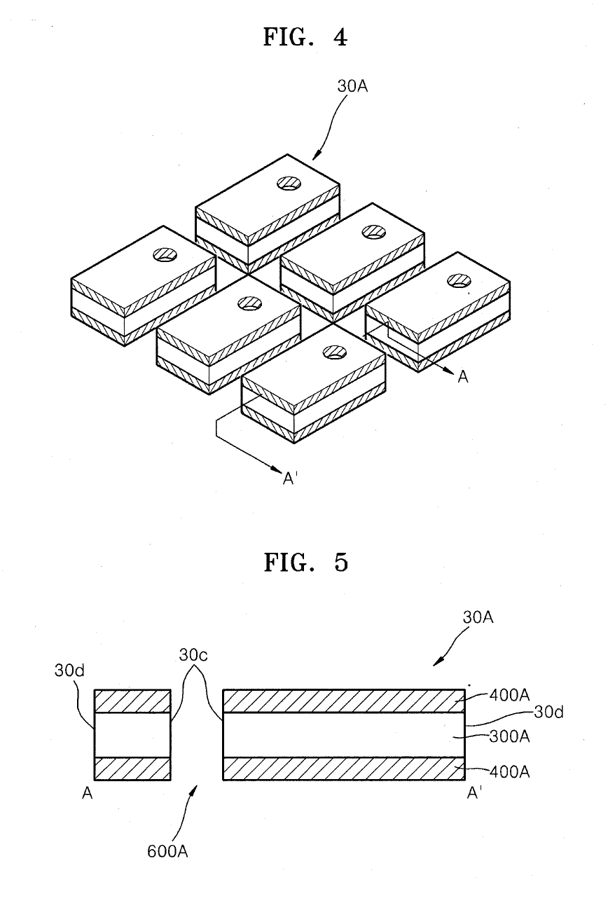

Referring to FIG. 4, the original glass substrate 300 on which the mask layers 400 are formed is cut along printed cutting lines or marks to form a plurality of unit glass substrate patterns 30A of cell units. The original glass substrate 300 may be divided into the unit glass substrate patterns 30A by using a physical processing method such as a water jet cutting method, a laser cutting method, or a scribing cutting method using a glass cutter. Here, the opening patterns 600 in the cover glass patterns 500 may be simultaneously cut and processed.

FIG. 5 is a cross-sectional view of a unit glass substrate pattern 30A taken along line A-A′ of FIG. 4. Referring to FIG. 5, the unit glass substrate pattern 30A includes a unit glass substrate 300A for example a part of the original glass substrate 300, and unit mask layers 400A that are parts of the mask layers 400 and disposed on opposite surfaces of the unit glass substrate 300A. An opening 600A is formed through the unit glass substrate 300A and the unit mask layers 400A by forming an opening pattern. Processing surfaces 30c and 30d of the unit glass substrate pattern 30A are damaged due to the physical process and are uneven, and thus, micro cracks may occur in the processing surfaces 30c and 30d.

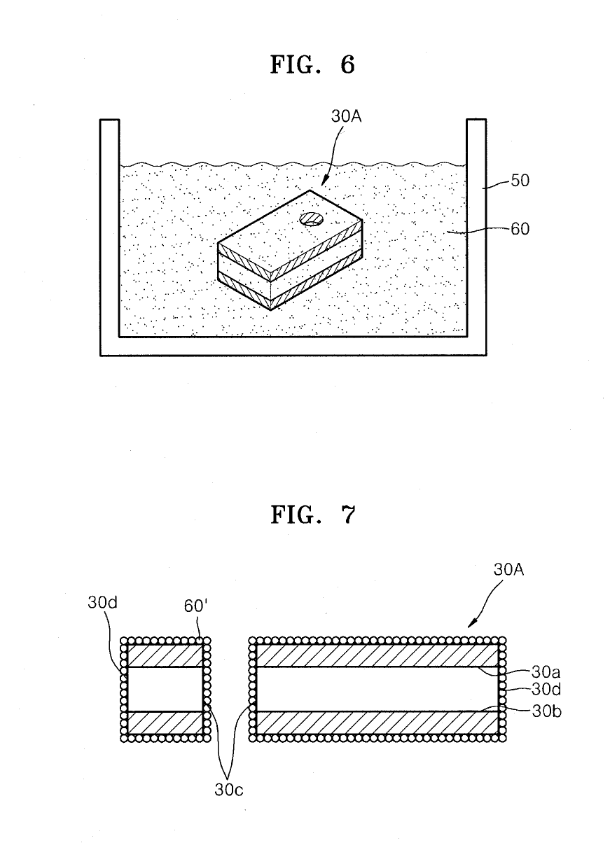

Referring to FIG. 6, the unit glass substrate pattern 30A is dipped in an etching solution 60 in an etching apparatus 50 to chemically etch the processing surfaces 30c and 30d. The etching solution 60 may be hydrofluoric acid (HF) or a mixture of HF and an inorganic acid. Here, the inorganic acid may be one or more selected from the group consisting of hydrochloric acid (HCl), nitric acid (HNO₃), and sulfuric acid (H₂SO₄). The unit glass substrate pattern 30A may be etched for less than 30 minutes by using HF of 1% to 10%. If a concentration of the HF solution is too high, the mask layers 400 melt so as not to protect the glass, and if the concentration of the HF solution is too low, it is not easy to remove stress on the processing surface. Optimal values of the concentration of the etching solution 60 and the etching time may be calculated in advance in order to improve the strength of the glass according to a kind and a thickness of the mask layer 400.

The chemical etching by the etching solution 60 makes the processing surface example damaged by the physical process uniform, and ions in the etching solution 60 infiltrate into the glass substrate to reinforce the glass so as to prevent fine cracks from generating. A thermal reinforcing method processes the glass substrate at a high temperature, thereby bending the glass substrate. In addition, since openings in the cover glass are very small, a physical process such as a polishing is not suitable. Therefore, the chemical etching is suitable for improving the strengths of the openings and the processing surface and making the surface uniform without a deformation such as a bending of the unit glass substrate 300A.

Conventionally, the entire glass substrate is chemically etched without forming an additional mask layer on the cut glass substrate of a cell unit, and thus, the glass substrate becomes slim. In this case, the entire surface of the glass substrate is etched, and thus, surface unevenness occurs. In addition, a processed portion such as an opening is greatly weakened due to the etching of the entire glass substrate. Also, there is a limitation in slimming the glass substrate through the etching of the entire glass substrate, in consideration of the strength of the surface processed through the cutting process.

According to the embodiment, as shown in FIG. 7, the unit glass substrate pattern 30A is dipped in the etching solution 60, and thus, molecules 60′ of the etching solution 60 are applied to exposed surfaces of the unit glass substrate pattern 30A. Here, the molecules 60′ are only applied to the exposed processing surfaces 30c and 30d of the unit glass substrate 300A due to the unit mask layers 400A formed on the opposite surfaces of the unit glass substrate pattern 300A, and then, the unit glass substrate pattern 30A is chemically etched selectively. Accordingly, the processing surfaces 30c and 30d may be made uniform, and the strength of the processing surface 30c of the opening 600A and the outer processing surface 30d may be improved. In addition, surfaces 30a and 30b of the unit glass substrate 300A are protected from the etching solution 60 by the unit mask layers 400A, and thus, the surfaces 30a and 30b of the unit glass substrate 300A are not etched and surface unevenness may be prevented. In addition, the cutting and etching processes may be performed by using an original glass substrate 300 of a desired thickness without performing the slimming of the entire glass substrate through the chemical etching and polishing.

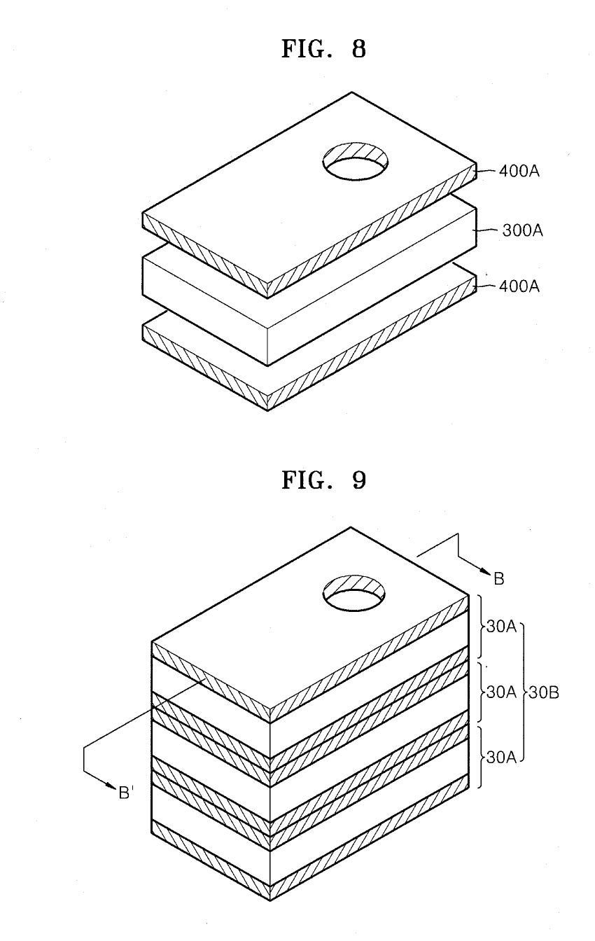

Referring to FIG. 8, the unit glass substrate pattern 30A for example chemically etched is dipped in a cleaning solution of a cleaning apparatus (not shown) to be cleaned. During the cleaning process, the unit mask layers 400A on the opposite surfaces of the unit glass substrate 300A are removed. The unit glass substrate 300A, from which the unit mask layers 400A are removed, is used as a cover glass. The thickness of the cover glass that becomes a product is 1 mm or less.

The cleaning solution may be fabricated by diluting an NaOH or a KOH aqueous solution in water or purified water. A concentration of the NaOH aqueous solution, which is effective to remove the unit mask layers 400A, is about 3 to 5%. A temperature for the cleaning process is about 40 to 80° C. For example, an ultrasound wave is irradiated onto the unit glass substrate pattern 30A for example dipped in the cleaning solution of a temperature of about 40 to 80° C., and after that, the glass substrate pattern 30A is washed by using water or purified water to remove the unit mask layers 400A.

In the embodiment of FIG. 8, the unit mask layers 400A on the opposite surfaces of the unit glass substrate 300A are isolated; however, the unit mask layers 400A may be dissolved by the cleaning solution to be removed or isolated.

FIGS. 9 through 13 are schematic diagrams showing processes of manufacturing a cover glass, according to another embodiment. In the present embodiments, the process of forming the mask layers, the process of cover glass pattern masking, and the cutting process illustrated in FIGS. 2 through 4 are performed prior to processes shown in FIGS. 9 through 13.

As shown in FIGS. 2 through 4, the mask layers 400 are formed on opposite surfaces of an original glass substrate 300 for a display. The mask layers 400 may be formed by various printing methods such as a screen printing method, a laminate film method, a resist applying photolithography process, and other printing methods that may form mask layers of predetermined sizes on the original glass substrate 300. The mask layers 400 may comprise a material that is not dissolved by an etching solution in an etching process that is performed later. For example, the mask layers 400 may be films comprising acrylic resin and acrylic urethane resin, and may be attached to the opposite surfaces of the original glass substrate 300. Otherwise, the mask layers 400 may be formed by printing a UV ink on the opposite surfaces of the original glass substrate 300 and drying the ink. Here, the ink may comprise urethane resin or a compound including the urethane resin, and may be fabricated by mixing a hardener, a pigment, an additive, and a solvent in a UV ink resin. The UV ink is applied to a thickness of about 60 to 70 μm by the screen printing method, and then is cured by UV light. An intensity of the UV light may range 2500±500 mj/cm² to process and protect the glass.

Next, a plurality of cover glass patterns 500 are formed on a mask layer 400 on a surface of the original glass substrate 300 according to a size and a shape of the cover glass to be manufactured, by printing a chemical-resistant ink in a spin coating method. In addition, opening patterns 600 are printed in the cover glass patterns 500. Otherwise, the cover glass patterns 500 and the opening patterns 600 may be marked in the mask layer 400 by using a flatbed cutting or a laser cutting method.

Next, the original glass substrate 300 on which the mask layers 400 are formed is cut along printed cutting lines or marks to form a plurality of unit glass substrate patterns 30A of cell units. The original glass substrate 300 may be divided into the unit glass substrate patterns 30A by using a physical processing method such as a water jet cutting method, a laser cutting method, or a scribing cutting method using a glass cutter. Here, the opening patterns 600 in the cover glass patterns 500 may be simultaneously cut and processed.

Referring to FIG. 9, a plurality of unit glass substrate patterns 30A are stacked to form a stacked glass substrate pattern 30B. Each of the unit glass substrate patterns 30A includes the unit glass substrate 300A that is a part of the original glass substrate 300, and the unit mask layers 400A that are parts of the mask layers 400 disposed on opposite surfaces of the unit glass substrate 300A, and an opening 600A is formed through the unit glass substrate 300A and the unit mask layers 400A by forming the opening pattern 600.

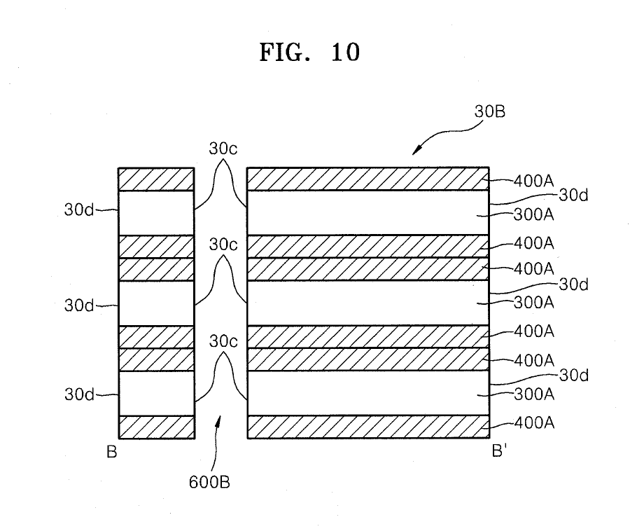

FIG. 10 is a cross-sectional view of the stacked glass substrate pattern 30B taken along a line B-B′ of FIG. 9. Referring to FIG. 10, the stacked glass substrate pattern 30B includes the stacked unit glass substrate patterns 30A. Therefore, the unit mask layers 400A of the adjacent unit glass substrate patterns 30A in a vertical direction contact each other. Here, the unit mask layers 400A contacting each other may be attached to each other by moisture and not using an additional adhesive, and thus, it is easy to stack the unit glass substrates 300A. Otherwise, an adhesive having a temporary adhesive force may be applied on the unit mask layers 400A to stack the unit glass substrate patterns 30A. The stacked glass substrate pattern 30B has an opening 600B and outer processing surfaces 30c and 30d through the physical processes.

Referring to FIG. 11, the stacked glass substrate pattern 30B is dipped in the etching solution 60 of an etching apparatus 50 to chemically etch the processing surfaces 30c and 30d with the etching solution 60. The etching apparatus 50 includes a supporting member (not shown) supporting an uppermost surface and a lowermost surface of the stacked glass substrate pattern 30B to fix the stacked glass substrate pattern 30B in the etching apparatus 50 during the chemical etching process. The etching solution 60 may be a solution of HF or a mixed solution of HF and an inorganic acid. The inorganic acid may be one or more selected from the group consisting of hydrochloric acid (HCl), nitric acid (HNO₃), and sulfuric acid (H₂SO₄). The stacked glass substrate pattern 30B may be etched for less than 30 minutes by using HF of 1% to 10%. If a concentration of the HF solution is too high, the mask layers 400 melt so as not to protect the glass, and if the concentration of the HF solution is too low, it is not easy to remove stress on the processing surfaces. Optimal values of the concentration of the etching solution 60 and the etching time may be calculated in advance in order to improve the strength of the glass according to a kind and a thickness of the mask layer 400.

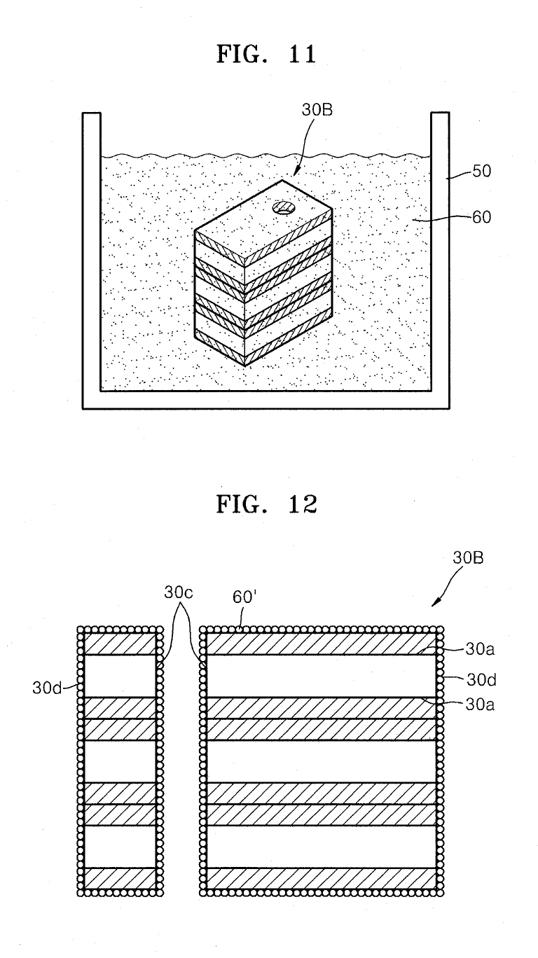

According to the embodiment, as shown in FIG. 12, molecules 60′ of the etching solution 60 are applied to exposed surfaces of the stacked glass substrate pattern 30B. Here, the molecules 60′ are only applied to exposed processing surfaces 30c and 30d of the unit glass substrate 300A due to the unit mask layers 400A formed on the opposite surfaces of the unit glass substrate pattern 300A, and then, the stacked glass substrate pattern 30B is chemically etched selectively. Accordingly, the processing surfaces 30c of the opening 600B and the outer processing surfaces 30d are chemically etched selectively, thereby improving the strength.

According to the embodiment, since the stacked glass substrate pattern 30B is dipped in the etching solution 60, surfaces of the glass substrates 300A contacting the molecules 60′ of the etching solution 60 may be reduced when compared with a case where the unit glass substrate pattern 30A is dipped in the etching solution 60, and thus, the stacked glass substrate pattern 30B is easily cleaned. In addition, since the plurality of unit glass substrate patterns 30A may be chemically etched by one chemical etching process, working efficiency is improved. In addition, defects that may be caused in a process of etching a single thin glass substrate may be reduced, and thus, yield may be improved.

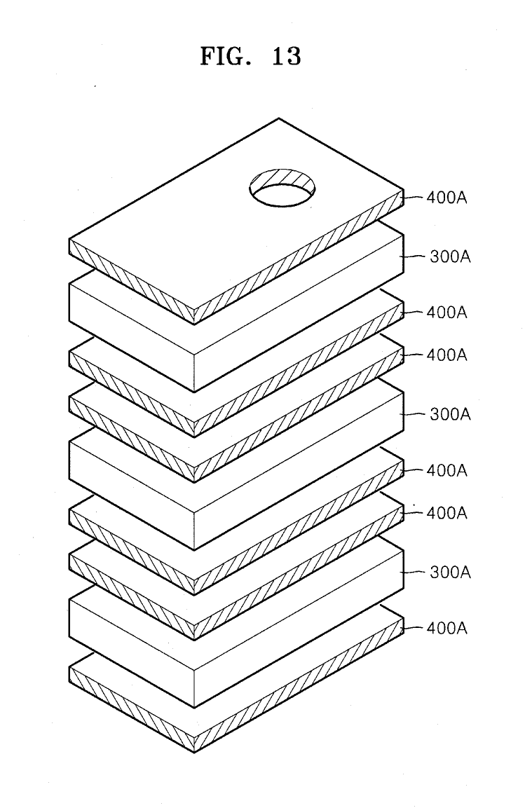

Referring to FIG. 13, the stacked glass substrate pattern 30B that is chemically etched is dipped in a cleaning solution of a cleaning apparatus (not shown) to be cleaned. During the cleaning process, the unit mask layers 400A on the opposite surfaces of the unit glass substrates 300A are removed. The unit glass substrate 300A, on which the unit mask layers 400A are removed, is used as a cover glass. The thickness of the cover glass that becomes a product is 1 mm or less.

The cleaning solution may be fabricated by diluting NaOH or KOH aqueous solution in water or purified water. A concentration of the NaOH aqueous solution, which is effective to remove the unit mask layers 400A, is about 3 to 5%. A temperature for the cleaning process is about 40 to 80° C. For example, an ultrasound wave is irradiated onto the stacked glass substrate pattern 30B that is dipped in the cleaning solution of a temperature of about 40 to 80° C., and after that, the stacked glass substrate pattern 30B is washed by using water or purified water to remove the unit mask layers 400A.

In the embodiment of FIG. 13, the unit mask layers 400A on the opposite surfaces of the unit glass substrates 300A are isolated; however, the unit mask layers 400A may be dissolved by the cleaning solution to be removed or isolated.

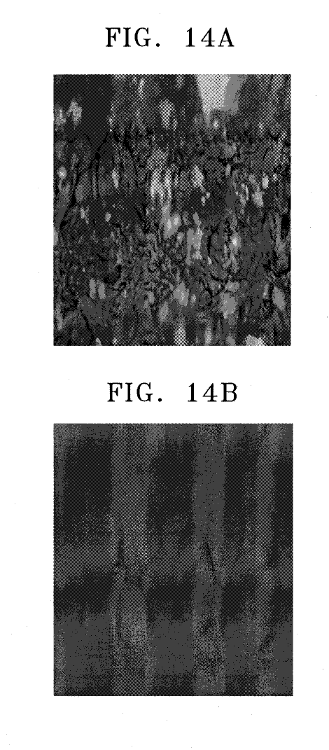

FIGS. 14A and 14B are photographs showing processing surfaces before and after the chemical etching process according to the embodiment. When the cutting process of the original glass substrate 300 is performed by using the physical processing method, the processing surfaces are damaged as shown in FIG. 14A. After that, the chemical etching is performed on the processing surfaces, the damaged processing surfaces shown in FIG. 14A are made uniform and reinforced as shown in FIG. 14B.

The following table 1 shows results of dropping experiments of a cover glass according to whether or not the chemical etching is performed.

TABLE 1

| | HF | | |
|---|---|---|---|
| | concentration | Etching | |
| | (%) | time (min) | Drop height (cm) |
| Cover glass chemically | 7.5 | 2 | 60 |
| etched according to | | 5 | 60 |
| embodiments | 15 | 2 | 60 |
| | | 5 | 60 |
| | | 10 | 60 |
| Cover glass that is not | — | — | 20 |
| chemically etched | | | |

Referring to Table 1, the cover glass having an opening according to the embodiment is chemically etched in a constant etching solution concentration and etching time, and thus, there is no damage to the cover glass even when dropped from a height of 60 cm. However, although the cover glass that is not chemically etched is not damaged when it is dropped from a height of 20 cm or lower, the cover glass is damaged when it is dropped from a height that is higher than 20 cm. The physically processed portion such as the opening in the cover glass is reinforced by the chemical etching process.

Following table 2 shows results of dropping experiments according to a thickness of a cover glass. Dropping experiments were performed with respect to a cover glass that is not chemically etched and a cover glass that is chemically etched.

TABLE 2

| Thickness (mm) | HF etching | Drop height (cm) |
|---|---|---|
| 0.7 | x | 20~48 (25) |
| 0.5 | x | 15~40 (25) |
| 0.5 | ∘ | 30~75 (50) |

As shown in Table 2, the cover glass that is not chemically etched was damaged when it is dropped from a height ranging from about 15 to about 48 cm (average 25 cm); however, the cover glass that is chemically etched was damaged when it is dropped from a height ranging from about 30 to about 75 cm (average 50 cm). In addition, the cover glass that is chemically etched has a higher strength than that of the cover glass that is not chemically etched even with a less thickness. The physically processed portion such as the opening in the cover glass is reinforced by the chemical etching process, and thus, an additional slimming process is not necessary.

According to the present embodiments, the physical process and the chemical etching are performed after forming mask layers on a glass, thereby improving a strength of the processing surfaces such as openings.

While the present embodiments have been particularly shown and described with reference to example embodiments thereof, it will be understood by those of ordinary skill in the art that various changes in form and details may be made therein without departing from the spirit and scope of the present embodiments as defined by the following claims.

What is claimed is:

1. A method of processing a cover glass, comprising:
forming mask layers on opposite surfaces of an original glass substrate;
cutting the original glass substrate into a plurality of unit glass substrates each including an opening;
chemically etching exposed processing surfaces of unit glass substrates by dipping the unit glass substrate in an etching solution; and
removing the mask layers by dipping the unit glass substrates in a cleaning solution.

2. The method of claim 1, wherein the cutting of the original glass substrate comprises processing the opening in each of the unit glass substrates.

3. The method of claim 1, wherein the forming of the mask layers comprises performing a printing on the opposite surfaces of the original glass substrate by using an ink.

4. The method of claim 3, wherein the ink is an ultraviolet (UV) ink comprising urethane resin or a compound including urethane resin.

5. The method of claim 1, wherein the forming of the mask layers comprises attaching protective films on the opposite surfaces of the original glass substrate.

6. The method of claim 5, wherein the protective film comprises acrylic resin and acrylic urethane resin.

7. The method of claim 1, wherein the etching solution comprises hydrofluoric acid (HF) or a mixed solution of HF and an inorganic acid.

8. The method of claim 7, wherein the inorganic acid is one or more selected from the group consisting of hydrochloric acid (HCl), nitric acid (HNO₃), and sulfuric acid (H₂SO₄).

9. The method of claim 1, wherein the cutting of the original glass substrate comprises cutting the original glass substrate by using a physical process.

10. A method of processing a cover glass, comprising:
forming mask layers on opposite surfaces of an original glass substrate;
cutting the original glass substrate into a plurality of unit glass substrates each including an opening;
stacking the plurality of unit glass substrates;
chemically etching exposed processing surfaces of the stacked unit glass substrates by dipping the stacked unit glass substrates in an etching solution; and
removing the mask layers by dipping the stacked unit glass substrates in a cleaning solution.

11. The method of claim 10, wherein the cutting of the original glass substrate comprises processing the opening in each of the unit glass substrates.

12. The method of claim 10, wherein the forming of the mask layers comprises performing a printing on the opposite surfaces of the original glass substrate by using an ink.

13. The method of claim 12, wherein the ink is an ultraviolet (UV) ink comprising urethane resin or a compound including urethane resin.

14. The method of claim 10, wherein the forming of the mask layers comprises attaching protective films on the opposite surfaces of the original glass substrate.

15. The method of claim 14, wherein the protective film comprises acrylic resin and acrylic urethane resin.

16. The method of claim 10, wherein the etching solution comprises hydrofluoric acid (HF) or a mixed solution of HF and an inorganic acid.

17. The method of claim 16, wherein the inorganic acid is one or more selected from the group consisting of hydrochloric acid (HCl), nitric acid (HNO₃), and sulfuric acid (H₂SO₄).

18. The method of claim 10, wherein the cutting of the original glass substrate comprises cutting the original glass substrate by using a physical process.

19. A display apparatus comprising a cover glass manufactured by the method according to claim 1.

20. A display apparatus comprising a cover glass manufactured by the method according to claim 10.
